(19) United States
(12) Patent Application Publication
(10) Pub. No.: US 2015/0050424 A1
(43) Pub. Date: Feb. 19, 2015

(54) METHODS AND COMPOSITION FOR DETECTION OF SURFACE DEFECTS IN SURFACE FINISHING OPERATIONS

(71) Applicant: Cal-West Specialty Coatings, Inc., Sunnyvale, CA (US)

(72) Inventor: Christopher Edward Woodhall, Sunnyvale, CA (US)

(21) Appl. No.: 14/339,221

(22) Filed: Jul. 23, 2014

Related U.S. Application Data
(60) Provisional application No. 61/861,229, filed on Aug. 1, 2013.

(51) Int. Cl. B05D 7/14; B05C 17/005; B05D 1/28; B05D 7/00; B05D 1/02

(52) U.S. Cl. CPC B05D 7/14; B05D 7/53; B05D 1/02; B05D 1/28; B05C 17/005
USPC 427/402; 427/444; 427/421.1; 427/428.01; 427/429; 118/264; 106/285

(57) ABSTRACT

In various embodiments, methods are provided for detecting surface defects in in the preparation of a surface for overcoating (e.g., in a painting operation) where the method comprises applying to a surface being prepared for overcoating a highlighting liquid composition that increases the gloss of the surface onto which is applied, wherein said highlighting liquid substantially comprises odorless mineral spirits; examining the glossy surface for surface shape irregularities; and removing any noted surface shape irregularities by mechanical means.

### CROSS-REFERENCE TO RELATED APPLICATIONS

This application claims benefit of and priority to U.S. Ser. No. 61/861,229, filed on Aug. 1, 2013, which is incorporated herein by reference in its entirety for all purposes.

### STATEMENT OF GOVERNMENTAL SUPPORT

[Not Applicable]

### BACKGROUND

Surface finishing processes, particularly repair processes in the automotive refinish industry, involve the application of fillers to imperfections in the surface followed by progressive abrasion with coarser to finer abrasive materials until the desired smooth surface is achieved. A series of protective coatings is typically applied, e.g., primer, sealers, base coats, clear coats, and so forth, and each layer is normally abraded prior to application of the next coat in order to ensure a smooth surface. A smooth surface is obtained by preferentially abrading high spots and filling low spots until a uniform flat aesthetically pleasing surface is obtained.

In order to assist the operator in identifying areas requiring abrasion and highlighting defects during the repair process, it is known to apply a guide coat to the surface being abraded. The guide coats generally comprise a dilute paint mixture that are sprayed over the surface to be abraded providing a light paint coating. As the surface is abraded, the guide coat is removed from the higher portions of the surface leaving the visible guide coat on the lower areas. Thus, the surface irregularities are clearly visible to the operator, enabling the operator to abrade and fill the appropriate areas to achieve a flat high quality repair.

Various current guide coats are applied as thin coatings of liquid paint which must dry or cure before the sanding operation. Aerosol paints, which are commonly thermoplastic lacquer based materials, are convenient to use and dry quickly when compared to automotive paints or primers when used as guide coats. However, thermoplastic materials tend to load the abrasive disc during the sanding operation which decreases cut rate and disc life compared to crosslinked thermoset materials. Disadvantages of crosslinked paints or primers when used as guide coats are that they are usually multi-component, higher solids, slower drying and less convenient compared to the aerosol products. Another drawback is that they crosslink to the surface and typically require an abrasion operation to remove.

Some people apply commonly available wax and grease removers which are typically comprised of one or more solvents and other materials. These products do not level well nor do they create the desired amount of gloss to function effectively in highlighting surface defects. Consequently, they do not provide the operator the optimum ability to identify defects. Also, these products dissipate at a high rate and frequently do not provide sufficient time for the operator to fully check the surface. This requires the operator to perform multiple applications. This is particularly problematic in warm, low humidity environments. Additionally, some of these products leave a residue that must be removed through an additional operation in order to avoid impairing the adhesion of subsequent coatings. These compounds often also have offensive odors.

### SUMMARY

In various embodiments, methods are provided for the detection of surface defects in the preparation of surfaces for an overcoating (e.g., a painting operation). Without being bound by a particular theory, it was determined that highlighting fluids substantially comprising odorless mineral spirits offer numerous advantages when used to detect surface defects, e.g., in a painting operation.

In various aspects, the invention(s) contemplated herein may include, but need not be limited to, any one or more of the following embodiments:

### Embodiment 1

A method of detecting defects in a surface, said method including: applying to a surface a highlighting liquid composition that increases the gloss of the surface onto which is applied, wherein said highlighting liquid substantially includes odorless mineral spirits; examining the glossy surface for surface shape irregularities; and removing any noted surface shape irregularities by mechanical means.

### Embodiment 2

The method of embodiment 1, wherein said method includes repeating said applying and examining and, if further shape irregularities are detected, removing any noted surface shape irregularities by mechanical means.

### Embodiment 3

The method according to any one of embodiments 1-2, wherein said method includes defect detection in the preparation of a surface for overcoating, and said applying includes applying to a surface that is to be subsequently overcoated.

### Embodiment 4

The method according to any one of embodiments 1-3, wherein said mechanical means includes abrading high areas and/or filling low areas.

### Embodiment 5

The method according to any one of embodiments 1-4, wherein said mechanical means includes pushing, pounding, pulling, or otherwise shaping the surface.

### Embodiment 6

The method according to any one of embodiments 1-5, wherein said surface is the surface of the body of a vehicle.

### Embodiment 7

The method of embodiment 6, wherein said surface is a surface of the body of a vehicle selected from the group consisting of a car, a truck, a bus, an airplane, a motorcycle, an ATV, and a boat.

### Embodiment 8

The method according to any one of embodiments 6-7, wherein said surface comprises a surface selected from the group consisting of a plastic surface, a metal surface, a fiberglass surface, and a Kevlar surface.

### Embodiment 9

The method according to any one of embodiments 6-8, wherein said surface is an unpainted surface.

### Embodiment 10

The method according to any one of embodiments 6-9, wherein said surface includes a bare metal surface of an automobile, truck, bus, or motorcycle.

### Embodiment 11

The method of embodiment 10, wherein said surface includes a surface that has been coated with plastic filler.

### Embodiment 12

The method according to any one of embodiments 6-7, wherein said surface includes a painted surface.

### Embodiment 13

The method of embodiment 12, wherein said surface includes a surface coated with a primer.

### Embodiment 14

The method according to any one of embodiments 2-12, wherein said method further includes applying an overcoating to said surface.

### Embodiment 15

The method of embodiment 14, wherein said applying occurs without taking actions to substantially remove said highlighting composition.

### Embodiment 16

The method of embodiment 14, wherein said applying occurs without washing or utilizing an abrasive to remove said highlighting composition.

### Embodiment 17

The method according to any one of embodiments 14-16, wherein said applying an overcoating includes applying a primer.

### Embodiment 18

The method according to any one of embodiments 14-17, wherein said applying an overcoating includes applying a base coat.

### Embodiment 19

The method according to any one of embodiments 14-18, wherein said applying an overcoating includes applying a clear coat.

### Embodiment 20

The method according to any one of embodiments 1-19, wherein said highlighting composition is applied to said surface using a device selected from the group consisting of a pressurized spray can, a pump sprayer, a paint sprayer, an impregnated cloth or sponge, an applicator pad containing the highlighting composition, a roller, and a brush.

### Embodiment 21

The method according to any one of embodiments 1-20, wherein said highlighting liquid is an isoparaffinic solvent substantially free of aromatic compounds.

### Embodiment 22

The method of embodiment 21, wherein said highlighting liquid is an isoparaffinic solvent including less than 3% aromatic compounds.

### Embodiment 23

The method of embodiment 21, wherein said highlighting liquid is an isoparaffinic solvent including less than 2% aromatic compounds.

### Embodiment 24

The method of embodiment 21, wherein said highlighting liquid is an isoparaffinic solvent including about 1% aromatic compounds.

### Embodiment 25

The method according to any one of embodiments 1-24, wherein said highlighting liquid does not contain particulates and/or extenders.

### Embodiment 26

The method according to any one of embodiments 1-25, wherein said highlighting liquid does not contain an antiloading agent.

### Embodiment 27

The method of embodiment 26, wherein said highlighting liquid does not contain an antiloading agent described in U.S. Pat. No. 5,853,467.

### Embodiment 28

The method according to any one of embodiments 1-27, wherein said highlighting liquid does not contain a solvent other than an isoparaffinic solvent.

### Embodiment 29

The method according to any one of embodiments 1-28, wherein said highlighting liquid does not contain a surfactant.

### Embodiment 30

The method according to any one of embodiments 1-29, wherein said highlighting liquid does not contain a thickener.

### Embodiment 31

A method of forming a guide coat on a surface to detect defects thereon characterized in that the method includes distributing over the surface a liquid highlighting composition that increases the gloss of the surface onto which is applied, wherein said highlighting liquid substantially includes odorless mineral spirits.

### Embodiment 32

The method of embodiment 31, wherein said surface is the surface of an automobile.

### Embodiment 33

The method of embodiment 32, wherein said surface includes a bare metal surface of an automobile.

### Embodiment 34

The method of embodiment 32, wherein said surface includes a painted surface of an automobile.

### Embodiment 35

The method according to any one of embodiments 31-34, wherein said guide coat does not need to be removed from said surface to permit painting of said surface.

### Embodiment 36

The method according to any one of embodiments 31-35, wherein said highlighting composition is applied to said surface using a device selected from the group consisting of a pressurized spray can, a pump sprayer, a paint sprayer, an impregnated cloth or sponge, an applicator pad containing the highlighting composition, a roller, and a brush.

### Embodiment 37

The method according to any one of embodiments 31-36, wherein said highlighting liquid is an isoparaffinic solvent substantially free of aromatic compounds.

### Embodiment 38

The method of embodiment 37, wherein said highlighting liquid is an isoparaffinic solvent including less than 3% aromatic compounds.

### Embodiment 39

The method of embodiment 37, wherein said highlighting liquid is an isoparaffinic solvent including less than 2% aromatic compounds.

### Embodiment 40

The method of embodiment 37, wherein said highlighting liquid is an isoparaffinic solvent including about 1% aromatic compounds.

### Embodiment 41

The method according to any one of embodiments 31-40, wherein said highlighting liquid does not contain particulates and/or extenders.

### Embodiment 42

The method according to any one of embodiments 31-41, wherein said highlighting liquid does not contain an antiloading agent.

### Embodiment 43

The method of embodiment 42, wherein said highlighting liquid does not contain an antiloading agent described in U.S. Pat. No. 5,853,467.

### Embodiment 44

The method according to any one of embodiments 31-43, wherein said highlighting liquid does not contain a solvent other than an isoparaffinic solvent.

### Embodiment 45

The method according to any one of embodiments 31-44, wherein said highlighting liquid does not contain a surfactant.

### Embodiment 46

The method according to any one of embodiments 31-45, wherein said highlighting liquid does not contain a thickener.

### Embodiment 47

The method according to any one of embodiments 31-46, characterized in that it includes the additional step of sanding the guide coated surface.

### Embodiment 48

A surface bearing a guide coat characterized in that the guide coat includes a liquid highlighting composition that increases the gloss of the surface onto which is applied, wherein said highlighting liquid substantially includes odorless mineral spirits.

### Embodiment 49

The surface of embodiment 48, wherein said surface is the surface of an automobile body.

### Embodiment 50

The surface of embodiment 49, wherein said surface includes a bare metal surface of an automobile.

### Embodiment 51

The surface of embodiment 49, wherein said surface includes a painted surface of an automobile.

### Embodiment 52

The surface according to any one of embodiments 48-51, wherein said guide coat does not need to be removed from said surface to permit painting of said surface.

### Embodiment 53

The surface according to any one of embodiments 48-52, wherein said highlighting liquid is an isoparaffinic solvent substantially free of aromatic compounds.

### Embodiment 54

The surface of embodiment 53, wherein said highlighting liquid is an isoparaffinic solvent including less than 3% aromatic compounds.

### Embodiment 55

The surface of embodiment 53, wherein said highlighting liquid is an isoparaffinic solvent including less than 2% aromatic compounds.

### Embodiment 56

The surface of embodiment 53, wherein said highlighting liquid is an isoparaffinic solvent including about 1% aromatic compounds.

### Embodiment 57

The surface according to any one of embodiments 48-56, wherein said highlighting liquid does not contain an antiloading agent.

### Embodiment 58

The surface of embodiment 57, wherein said highlighting liquid does not contain an antiloading agent described in U.S. Pat. No. 5,853,467.

### Embodiment 59

The surface according to any one of embodiments 48-58, wherein said highlighting liquid does not contain a solvent other than an isoparaffinic solvent.

### Embodiment 60

The surface according to any one of embodiments 48-59, wherein said highlighting liquid does not contain a surfactant.

### Embodiment 61

The surface according to any one of embodiments 48-60, wherein said highlighting liquid does not contain a thickener.

### Embodiment 62

An apparatus for applying a highlighting fluid to a surface to detect defects thereon including an applicator pad effective to contain and apply a highlighting composition that increases the gloss of the surface onto which is applied, wherein said highlighting liquid substantially includes odorless mineral spirits.

### Embodiment 63

The apparatus of embodiment 62, characterized in that said applicator pad is impregnated with said highlighting composition.

### Embodiment 64

The apparatus according to any one of embodiments 62-63, characterized in that said apparatus further includes a handle secured to an application pad and further a reservoir located inside said handle and/or adjacent to said application pad containing said highlighting liquid wherein said apparatus is configured to deliver said highlighting composition to said application pad.

### Embodiment 65

The apparatus according to any one of embodiments 62-64, wherein said highlighting liquid is an isoparaffinic solvent substantially free of aromatic compounds.

### Embodiment 66

The apparatus of embodiment 65, wherein said highlighting liquid is an isoparaffinic solvent including less than 3% aromatic compounds.

### Embodiment 67

The apparatus of embodiment 65, wherein said highlighting liquid is an isoparaffinic solvent including less than 2% aromatic compounds.

### Embodiment 68

The apparatus of embodiment 65, wherein said highlighting liquid is an isoparaffinic solvent including about 1% aromatic compounds.

### Embodiment 69

The apparatus according to any one of embodiments 62-68, wherein said highlighting liquid does not contain an antiloading agent.

### Embodiment 70

The apparatus of embodiment 69, wherein said highlighting liquid does not contain an antiloading agent described in U.S. Pat. No. 5,853,467.

### Embodiment 71

The apparatus according to any one of embodiments 62-70, wherein said highlighting liquid does not contain a solvent other than an isoparaffinic solvent.

### Embodiment 72

The apparatus according to any one of embodiments 62-71, wherein said highlighting liquid does not contain a surfactant.

### Embodiment 73

The apparatus according to any one of embodiments 62-72, wherein said highlighting liquid does not contain a thickener.

### Embodiment 74

A method for detecting defects on a painted surface, the method including the steps of: applying to a surface being prepared for overcoating a highlighting liquid composition that increases the gloss of the surface onto which is applied, wherein said highlighting liquid substantially includes odorless mineral spirits; examining the glossy surface for surface shape irregularities identifying those irregularities for removal.

### BRIEF DESCRIPTION OF THE DRAWINGS

FIG. 1 illustrates a perspective view of one illustrative embodiment of an applicator for a highlighting composition for use in the methods described herein.

FIG. 2 illustrates a cross-section through applicator for a highlighting composition for use in the methods described herein.

### DETAILED DESCRIPTION

In various embodiments, methods are provided for the detection of surface defects in the preparation of surfaces for an overcoating (e.g., a painting operation). When a surface such as that of a vehicle body is being refinished, particularly after repair of accident damage, it is common practice to apply body fillers and stoppers (a very fine filler) and a series of layers of primers, stone chip or corrosion protection coatings, paint coats and sealants, and the like, that are each rubbed down before application of the next coat in order to obtain a smooth surface and to assist in re-working of top paint coats and lacquers. Filling materials are used to repair indentations, scratches etc., and these are prepared by sanding, filing and other abrasive techniques to achieve a smooth surface. This may be done using power assisted equipment or by hand. A range of abrasive materials may be used such as sand papers, production papers, wet and dry abrasive papers and sanding pads. Coarse abrasives are initially used then finer and finer abrasives until the desired finish is achieved.

These filling and smoothing operations are facilitated by the use of compositions to improve the improving the detection of surface defects. In particular, liquid “highlighting” compositions are provided that when applied to a surface increase the gloss of the surface onto which they are applied rendering surface defects (scratches, indentations, high points, etc.) more visible and directing an operator to abrade and/or fill the surface defect appropriately.

In use, the compositions are applied to a surface in question (e.g., via applicator, application cloth, pressurized spray can, pump sprayer, paint sprayer, brush, roller, etc.) where they increase the gloss of the surface. The surface is visually examined, preferably from an angle that is as close to zero degrees from the panel as possible. If there are no surface defects the reflection of ambient light or nearby objects will appear continuous and straight. If there are surface defects the reflections will appear discontinuous and/or curved or wavy. If the defect is in the form of a depression, scratch, or the like, a filler (e.g., Bondo) is applied as needed to eliminate the defect. The filler is allowed to dry and the area is abraded (e.g., sanded) until the filled area is smooth and even with the surrounding surfaces. If the defect is in the form of a protrusion or “high spot”, the protrusion is abraded, e.g., with sand paper or other abrasive material until it is level with the surrounding surface(s).

In various embodiments, the highlighting compositions have a slow/delayed evaporation rate so that they need not be frequently re-applied to the surface in order to maintain defect visibility. The compositions, however, do evaporate in a convenient time frame (typically about 15 to about 30 minutes at room temperature (e.g., 68F), more preferably about 15 to about 25 minutes, and most preferably about 20 minutes at room temperature.). Moreover, the highlighting compositions are compatible with overcoating materials (e.g., paint, clear coat, etc.). Accordingly the surface need not be cleaned after application of the highlighting composition before application of an overcoating.

In various embodiments, the highlighting liquid comprises odorless mineral spirits. in certain embodiments the highlighting composition consists essentially of odorless mineral spirits and in certain embodiments the highlighting liquid consists of odorless mineral spirits.

Odorless Mineral Spirits are a hydrocarbon solvent and typically isoparaffins, oil-like solvents derived from a petrochemical base typically using catalytic synthesis. in certain embodiments the odorless mineral spirits are substantially pure hydrocarbons. in certain embodiments the mineral spirits comprise a a mixture of fully saturated, linear and/or branched aliphatic hydrocarbons in the range of around C₇ or around C₉ to about C₁₃. The flash point of these products is typically (but not necessarily) in the 57 to 65° C. range which equals a boiling point of between 180° C. and 220° C. Depending on the product, the boiling range may be as narrow as 10 to 15° C.

Isoparaffinic solvents useful in the methods described herein are substantially free of aromatic compound. In certain embodiments the solvents are completely saturated and practically odorless. In addition to functioning as a highlighting fluid, they can dissolve and remove of oil residues from metal surfaces.

Odorless mineral spirits, or OMS, contemplated herein are mineral spirits that have been refined to remove the more toxic aromatic compounds (e.g., benzene, toluene and xylene). The mineral spirits (e.g., CAS 64475-85-0) contemplated herein, also known as Stoddard solvent (e.g., CAS 8052-41-3) or white spirits (U.K.), comprise a paraffin-derived clear, transparent liquid that is a common organic solvent that can be used in painting and decorating. Typically the mineral spirits contemplated herein comprise a mixture of aliphatic and alicyclic C₇ to C₁₂ hydrocarbons with a maximum content of 25% of C₇ to C₁₂ aromatic hydrocarbons. A typical composition for mineral spirits is the following: >65% C10 or higher hydrocarbons, aliphatic solvent hexane, and a maximum aromatic hydrocarbon content of 0.1% by volume, a kauri-butanol value of 29, an initial boiling point of about 149° F. (65° C.), a dry point of approximately 156° F. (69° C.), and a specific mass of about 0.7 g/cc. Stoddard solvent is a specific mixture of hydrocarbons typically >65% C10 or higher hydrocarbons.

In certain embodiments the highlighting liquids described herein comprise, consist essentially of, or consist of an isoparaffinic solvent substantially free of aromatic compounds. in certain embodiments the highlighting liquid is an isoparaffinic solvent comprising less than about 5% aromatic compounds, or less than about 4% aromatic compound, or less than about 3% aromatic compounds, or less than about 2% aromatic compounds, or less than about 1.5% aromatic compounds. In certain embodiments the highlighting liquid is an isoparaffinic solvent comprising about 1% aromatic compounds.

in certain embodiments the highlighting liquid does not contain particulates and/or extenders, and/or an antiloading agent (e.g., an antiloading agent described in U.S. Pat. No. 5,853,467), and/or a solvent other than an isoparaffinic solvent, and/or a surfactant, and/or a thickener.

In one illustrative embodiment, the highlighting fluid comprises, or consists essentially of, or consists of an odorless mineral spirit called SHELLSOL OMS®. SHELLSOL OMS is an isoparaffinic solvent which has been synthesized from selected hydrocarbons under conditions that exclude virtually all odor-producing fractions. Similar OMS is sold by Chevron Phillips, ExxonMobil, Dow Chemical, and others. The product is highly stable and retains its virtually odorless quality under normal conditions and extended storage. Properties characterizing SHELLSOL OMS® are shown in Tables 1 and 2.

TABLE 1
Sales specification for SHELLSOL OMS ® (product number Q7432).

| Property | Unit | Min | Max | Method |
|---|---|---|---|---|
| Appearance | | C1 & FFSM | | ASTM D4176 |
| Color | Saybolt | 30 | | ASTM D156 |
| Odor | | Pass | | ASTM D1296 |
| Density @15.6° C. | kg/m³ | 740 | 775 | ASTM D4052 (1) |
| Specific Gravity | | 0.740 | 0.775 | ASTM D4052 (1) |
| @15.6° C. | | | | |
| Copper Corrosion | | | 1 | ASTM D130 (1) |
| (3 hr @100° C.) | | | | |
| Distillation, IBP | ° C. | 171.0 | | ASTM D86 |
| Distillation, DP | ° C. | | 210.0 | ASTM D86 |
| Aromatics | % v/v | | 0.25 | ASTM D3257 (1) |
| Flash Point, TCC | ° C. | | 43.5 | ASTM D56 |
| Kauri-Butanol | | | 29 | ASTM D1133 (1) |
| Value | | | | |

(1) Guaranteed,
(2) Typical,
(3) Report Only,
(4) Guaranteed spec with typical result

Product meets Federal Specification A-A-2904 Type III. Conformance to specification limits is determined in accordance with ASTM E29, Rounding-off Method. Product contains approximately 25 ppm BHT.

TABLE 2
Typical properties for SHELLSOL OMS ® (product number Q7432).

| Property | Unit | Method | Value |
|---|---|---|---|
| Color | Saybolt | ASTM D156 | +30 |
| API Gravity | — | ASTM D4052 | 55 |
| Density @15° C. | kg/L | ASTM D4052 | 0.758 |
| Specific Gravity @15.6/ | — | ASTM D4052 | 0.759 |
| 15.6° C. | | | |
| Distillation, IBP | ° C. | ASTM D86 | 175 |
| Distillation, 50% v | ° C. | ASTM D86 | 182 |
| Distillation, DP | ° C. | ASTM D86 | 200 |
| Evaporation Time | seconds | ASTM D3539 | 4700 |
| (nBuAc = 470 sec) | | | |
| Relative Evaporation Rate | — | ASTM D3539 | 0.10 |
| (nBuAc = 1) | | | |
| Vapor Pressure @20° C. | kPa | Calculated | 0.1 |
| Paraffins | % wt | GC | 96 |
| Naphthenes | % wt | GC | 4 |
| Aromatics | % v/v | ASTM D3257 | <0.1 |
| Benzene | ppm | GC | <1 |
| Naphthalene | % m/m | GC | <0.1 |
| Flash Point | ° C. | ASTM D56 | 51 |
| Auto Ignition Temperature | ° C. | ASTM E659 | 348 |
| VOC Content | g/L | ASTM D4052 | 758 |
| Aniline Point (M = Mixed) | ° C. | ASTM D611 | 84 |
| Kauri-Butanol Value | — | ASTM D1133 | 29 |
| Hildebrand Solubility | (cal/cm³)\hat{ }½ | — | 7.4 |
| Parameter | | | |
| Hydrogen Bonding Index | — | — | 0.0 |
| Fractional Polarity | — | — | 0 |
| Viscosity @25° C. | cSt | ASTM D445 | 1.90 |
| Molecular Weight | g/mol | Calculated | 166 |

Other grades of minerals spirits that are less refined than SHELLSOL OMS can be used but will have more odor. While, in theory, there are many other solvents, oils, water and surfactants, acetone, lacquer thinner, etc. that can create a gloss and be applied to provide to varying degrees the ability to identify surface defects as well as color match, it was discovered that typical alternatives do not do not work as well as OMS because they leave a residue that must be removed, and/or have a bad odor, and/or dissipate too quickly or too slowly, and/or are too aggressive and harm the substrate, and/or are not sufficiently viscous and run off the substrate, and/or they do not lay out or level in a way that adequately simulates the look of a clear coat.

It is noted that compared to “standard mineral spirits”, OMS, has a lower concentration of aromatic solvents (e.g., benzene, toluene and xylene). The California standard is ˜3%, where OMS is usually around 1%.

In certain embodiments the highlighting fluid may be distributed over the surface by any suitable means, e.g., by spreading with a cloth, pad or sponge, by spraying using a pressurized spray can, pump sprayer, paint sprayer, and the like, by using a brush or a roller, and the like. In various embodiments, the highlighter fluid will bed be applied to surfaces to which filler has been applied and/or coated with primer, paint lacquer, and so forth, since these are the stages in the refinish industry where guide coats are generally employed. However, the highlighter compositions may be applied directly to non-treated surfaces if required, e.g., wood, metal, such as steel, plastic, fibre glass, and the like.

Where the highlighter fluid is provided in a pressurized spray can, the fluid is typically packaged in a pressurized container with a propellant. The level of propellant used as part of the aerosol system can vary. If the propellant level is too low the propellant may not adequately atomize the material for uniform application. If the propellant level is too high significant overspray onto surrounding areas can occur. Preferably the aerosol system comprises about 1 to about 70 percent or about 50 percent by weight of the propellant, based upon the total weight of the composition plus the propellant, more preferably about 2 to about 30 percent by weight of the propellant, based upon the total weight of the composition plus the propellant, and most preferably about 3 percent or about 5 percent to about 30 percent by weight of the propellant, based upon the total weight of the composition plus the propellant.

In certain embodiments, the propellant is selected from the group consisting of alkanes, alkenes, chlorofluorocarbons, and compressed gases such as nitrogen, carbon dioxide and nitrous oxide. In certain embodiments, the propellant is selected from the group consisting of propane, isoheptane, dimethyl ether (DME), methyl ethyl ether, and mixtures of volatile hydrocarbons, typically propane, n-butane and isobutane. In one illustrative, but non-limiting embodiment, the basic formulation is 95% odorless mineral spirits and 5% CO₂ (propellant) in an aerosol can.

The propellant can be combined with the composition according to procedures known to those skilled in the art to form an aerosol. It may be, intermixed therewith as one example, but may instead be in a separate compartment of a container, for example.

In various embodiments, the highlighter fluid product can also be applied in a non-aerosol pump sprayer or wiped-on with a cloth, sponge, brush, or applicator. In such embodiments, the formula can comprise about 100% odorless mineral spirits.

As indicated above, in certain embodiments, the highlighter fluid may be stored and dispensed onto the surface from a sponge, spray can, pump sprayer or similar container

In certain embodiments the highlighter fluid may be impregnated within the fibers of a fleece, mop, woven or non-woven fabric, or provided as a foam that may be wiped over the surface to deposit the fluid. In a further embodiment the highlighter fluid may be contained within the reservoir of an applicator and dispensed when the applicator is wiped over the surface.

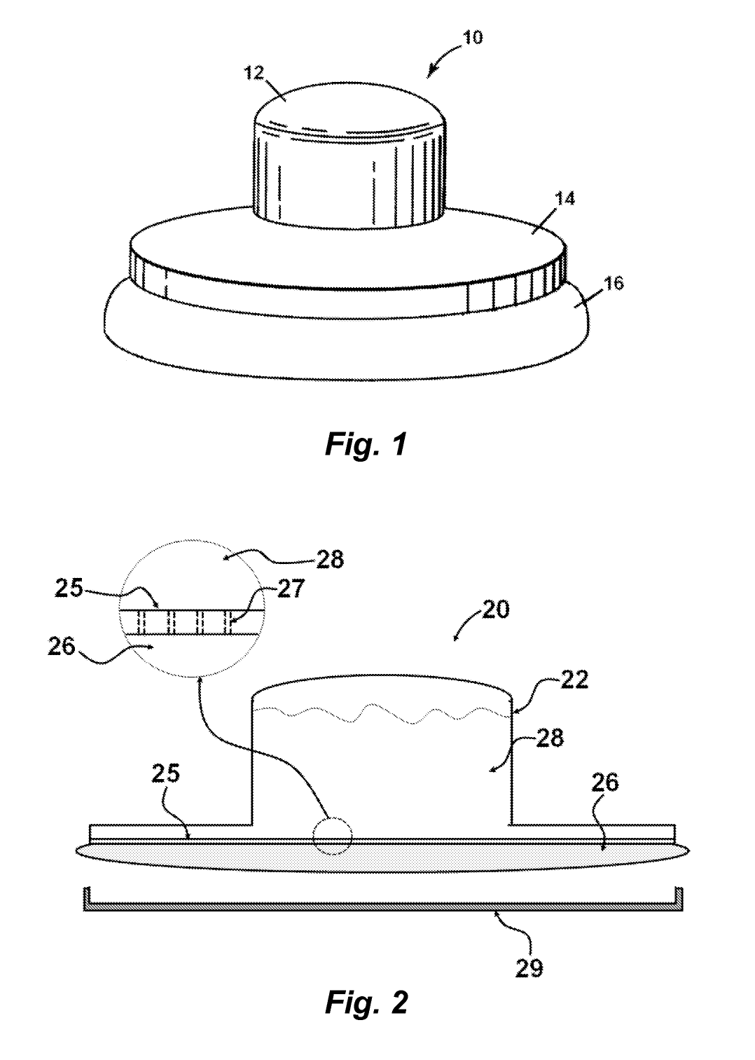

As illustrated in FIG. 1, in certain embodiments an applicator apparatus 10 is provided applying a highlighting fluid to a surface to detect defects thereon. In the illustrative, but non-limiting embodiment shown in FIG. 1 the applicator comprises a handle 12 secured to a support 14 that supports an applicator pad 16. In various embodiments, the handle 12 and support 14 also can be an integral molded body, such as a single integral element of molded rigid foam or a plastic shell. In various embodiments, the applicator pad 16 may comprise a mop, a fleece, a foam, a sponge, and the like. in certain embodiments the applicator pads 12 are removable from the support 14 in order that they may be replaced. However, in certain embodiments, the applicator apparatus 12 is provided as a single disposable unit. Any suitable fixing system may be employed to attach the applicator pad 16 such as those commonly used for attaching abrasive paper to the back-up pads of sanding devices. For example, the pad may be coated with a pressure-sensitive adhesive and adhered to the back-up pad. Alternatively the pad may be laminated to a Velcro band on one surface that cooperates with matching Velcro band provided on the surface of the support. For instance, in certain embodiments, the applicator can comprise a plastic handle molded onto the support 14 onto which a Velcro surface is laminated. This Velcro provides an attachment surface for applicator pad 16 bearing a mating Velcro surface.

As illustrated in FIG. 2, in certain embodiments, apparatus 20 may comprise a handle 22 that is hollowed to provide a reservoir space 23 for containing the highlighter fluid 28. Such a fluid storage handle can be associated with a delivery system 25 which will feed highlighter fluid through the support 24 to the applicator pad 26 to allow application of the fluid to a surface. In certain embodiments the delivery system 25 may comprise one or more holes 27 through the back-up pad. In certain embodiments a feed mechanism such as a pressurized chamber or compression of the handle may facilitate delivery of the fluid from the reservoir 23 to the applicator pad 26. The highlighter fluid is readily spread over a surface by application of light pressure to wipe the applicator pad over a surface. In certain embodiments the apparatus can be provided with a cover 29 to close the apparatus for storage.

In another embodiment, the applicator pad may be impregnated or loaded with the highlighter fluid and thereafter attached to the a support handle prior to use.

### EXAMPLES

The following examples are offered to illustrate, but not to limit the claimed invention.

### Example 1

### How to Use a Highlighting Composition Comprising Odorless Mineral Spirits on an Automobile

The OMS fluid is sprayed onto a bare metal panel that is being repaired. The panel is completely coated with the fluid. Film thickness should be about 0.1 mils. The surface of the panel is visually examined with the head/eyes located at an angle that is as close to zero degrees from the panel as possible. If there are no surface defects the reflection of ambient light or nearby objects will appear continuous and straight. If there are surface defects the reflections will appear discontinuous and/or curved or wavy. If the defect is in the form of a depression, depression or the like, filler (e.g., Bondo) is applied as needed to the eliminate the defect(s). The filler is allowed to dry and then the area is snaded until the filled area is smooth and even with the surrounding surfaces. If the defect is in the form of a protrusion or “high spot”, the protrusion is abraded with sand paper or other abrasive material until it is level with the surrounding surfaces.

The highlighting fluid is optionally reapplied and the area is examined as before. If there are still defects, filler is added to low spots and/or high spots are abraded as appropriate. The process can be repeated until there are no defects.

When no defects are found primer is applied to the surface. When the primer is dry, the highlighter fluid can be applied over the primer to help identify surface defects in the same way it was used to identify defects in the bare metal surface. Any defects found can then be corrected by adding filler or abrading high spots until the surface is straight and smooth. Similarly, this process can be performed after application of the base coat of paint.

### Example 2

### Notes on the Use of OMS for Surface Preparation

### OMS Highlighter Fluid (QUICK CHECK™)—Temporary Gloss for Body Shop Applications

Quick Check:
Can be used in the body shop or the paint shop;
Stays wet long enough so that the straightness of repaired panels can be evaluated; and
Dissipates completely without leaving any residue behind.

### Directions for Use:

Panel checking: To check straightness of a repaired panel, spray on bare panel. Examine panel for defects. Coverage is about 150 spray-out cards or 15 to 20 panels (about 6 square feet each) per can.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A method of detecting defects in a surface, said method comprising:
applying to a surface a highlighting liquid composition that increases the gloss of the surface onto which is applied, wherein said highlighting liquid substantially comprises odorless mineral spirits;
examining the glossy surface for surface shape irregularities; and
removing any noted surface shape irregularities by mechanical means.

2. The method of claim 1, wherein said method comprises repeating said applying and examining and, if further shape irregularities are detected, removing any noted surface shape irregularities by mechanical means.

3. The method of claim 1, wherein said method comprises defect detection in the preparation of a surface for overcoating, and said applying comprises applying to a surface that is to be subsequently overcoated.

4. The method of claim 1, wherein said mechanical means comprises abrading high areas and/or filling low areas.

5. The method of claim 1, wherein said mechanical means comprises pushing, pounding, pulling, or otherwise shaping the surface.

6. The method of claim 1, wherein said surface is the surface of the body of a vehicle.

7-10. (canceled)

11. The method of claim 1, wherein said surface comprises a surface that has been coated with plastic filler.

12-13. (canceled)

14. The method of claim 3, wherein said method further comprises applying an overcoating to said surface.

15. The method of claim 14, wherein said applying occurs without taking actions to substantially remove said highlighting composition.

16. (canceled)

17. The method of claim 14, wherein said applying an overcoating comprises applying a primer, and/or applying a base coat, and/or applying a clear coat.

18-19. (canceled)

20. The method of claim 1, wherein said highlighting composition is applied to said surface using a device selected from the group consisting of a pressurized spray can, a pump sprayer, a paint sprayer, an impregnated cloth or sponge, an applicator pad containing the highlighting composition, a roller, and a brush.

21. The method of claim 1, wherein said highlighting liquid is an isoparaffinic solvent substantially free of aromatic compounds.

22. The method of claim 21, wherein said highlighting liquid is an isoparaffinic solvent comprising less than 3% aromatic compounds.

23-24. (canceled)

25. The method of claim 1, wherein said highlighting liquid does not contain particulates and/or extenders, and/or does not contain an antiloading agent, and/or does not contain a solvent other than an isoparaffinic solvent, and/or does not contain a surfactant, and/or does not contain a thickener.

26-30. (canceled)

31. A method of forming a guide coat on a surface to detect defects thereon characterized in that the method comprises distributing over the surface a liquid highlighting composition that increases the gloss of the surface onto which is applied, wherein said highlighting liquid substantially comprises odorless mineral spirits.

32-47. (canceled)

48. A surface bearing a guide coat characterized in that the guide coat comprises a liquid highlighting composition that increases the gloss of the surface onto which is applied, wherein said highlighting liquid substantially comprises odorless mineral spirits.

49-61. (canceled)

62. An apparatus for applying a highlighting fluid to a surface to detect defects thereon comprising an applicator pad effective to contain and apply a highlighting composition that increases the gloss of the surface onto which is applied, wherein said highlighting liquid substantially comprises odorless mineral spirits.

63. The apparatus of claim 62, characterized in that said applicator pad is impregnated with said highlighting composition.

64. The apparatus of claim 62, characterized in that said apparatus further comprises a handle secured to an application pad and further a reservoir located inside said handle and/or adjacent to said application pad containing said highlighting liquid wherein said apparatus is configured to deliver said highlighting composition to said application pad.

65. The apparatus of claim 62, wherein said highlighting liquid is an isoparaffinic solvent substantially free of aromatic compounds.

66. The apparatus of claim 65, wherein said highlighting liquid is an isoparaffinic solvent comprising less than 3% aromatic compounds.

67-68. (canceled)

69. The apparatus of claim 62, wherein said highlighting liquid does not contain particulates and/or extenders, and/or does not contain an antiloading agent, and/or does not contain a solvent other than an isoparaffinic solvent, and/or does not contain a surfactant, and/or does not contain a thickener.

70-73. (canceled)

74. A method for detecting defects on a painted surface, said method comprising:
applying to a surface being prepared for overcoating a highlighting liquid composition that increases the gloss of the surface onto which is applied, wherein said highlighting liquid substantially comprises odorless mineral spirits;
examining the glossy surface for surface shape irregularities identifying those irregularities for removal.
